(19) United States
(12) Patent Application Publication
(10) Pub. No.: US 2008/0129122 A1
(43) Pub. Date: Jun. 5, 2008

(54) Controllable board-spectrum harmonic filter (CBF) for electrical power systems

(76) Inventors: Luke Yu, San Marino, CA (US); Henry Yu, San Marino, CA (US)

Correspondence Address: Gary F. Wang, Esq., Suite 302, 201 South Lake Avenue, Pasadena, CA, 91101, US

(21) Appl. No.: 10/901,265

(22) Filed: Jul. 27, 2004

Related U.S. Application Data
(63) Continuation-in-part of application No. 10/237,281, filed on Sep. 9, 2002, now abandoned.
(60) Provisional application No. 60/349,711, filed on Jan. 22, 2002.

(51) Int. Cl. H02J 3/01

(52) U.S. Cl. 307/105

(57) ABSTRACT

A broad-spectrum harmonic filter is developed. This filter is to be connected in series ahead of the load which generates harmonics. This filter basically consists of 3 fixed elements, i.e. a series reactor and a shunt reactor in series with a capacitor. It can function to completely filter out 5th harmonic current in 3 phase systems (or 3rd harmonic current in single phase systems) and to reduce other harmonic components by high percentages say, typically close to 70%. Thus the portions of various harmonics flowing toward the electrical power source can be held within acceptable limits.

### RELATED APPLICATION

This patent application is a continuation-in-part application and claims the priority date and the benefits of the U.S. patent application Ser. No. 10/237,281 filed on Sep. 9, 2002, which claims the priority date and the benefits of the U.S. provisional application Ser. No. 60/349,711 filed on Jan. 22, 2002.

### FIELD OF THE INVENTION

This invention relates to broad-spectrum harmonic filtration by use of inductor and capacitor combination for single and multiphase electrical power systems.

### BACKGROUND OF THE INVENTION

This invented filter can filter out all harmonics with high percentages of attenuation and thereby significantly reduce harmonics injected into the power source while the conventional L-C type (inductor-capacitor in series) filter is tuned at and can only filter one specific harmonic. The filtering performance can be controlled by proper selection of its design parameters.

Adjustable speed drives (ASD) are widely used in 3 phase 3 wire electrical systems. Those drives generate harmonics such as 5th, 7th, 11th, etc., which may feed back into the source power system.

Typically, the harmonic magnitudes in terms of ASD motor load current are as follows, expressed in per unit (pu) values:

| | | | | | | | | | |
|---|---|---|---|---|---|---|---|---|---|
| Harmonic | 1 | 5 | 7 | 11 | 13 | 17 | 19 | 23 | 25 |
| order | | | | | | | | | |
| Magni- | 1 | 0.2 | 0.12 | 0.08 | 0.07 | 0.045 | 0.04 | 0.03 | 0.03 |
| tude, | | | | | | | | | |
| pu | | | | | | | | | |

These harmonic currents flow toward the electrical system and create harmonic voltage distortion and other adverse effects in both the electrical systems and other elements. This has been well documented and long known to the industry.

Eliminating or reducing harmonics has become a topic for research and development with great significance. For 3 phase, 3 wire systems, the most popular filtering equipment is as follows:

Shunt L-C tuned filter: This type of filter, consisting of an inductor and a capacitor in series is widely used in industry for harmonic elimination purposes. By proper selection of values of the inductor and capacitor, a tuned filter can be created. Such a filter is very effective, but only for the specific harmonic for which it is tuned. Typically such filters are tuned for the 5th harmonic which has the highest magnitude of all in three phase ASD systems. However, this tuned filter becomes a high impedance path to other harmonics resulting in the other harmonics flowing toward the electrical system due to its relatively low impedance as compared to the filter impedance. In order to achieve useful harmonic elimination or reduction to an acceptable limit, many tuned filters are required in each separate application. This is an expensive method of harmonic reduction.

Active filter: This type of filter injects harmonic currents of opposing sense in order to cancel the generated harmonic currents. It is an effective method. However it is very costly and consists of many electronic components arranged in complex circuits. Its applications are limited.

Power factor correction capacitors very commonly exist in electrical distribution systems. They cannot alleviate harmonics, but may in turn aggregate harmonics and create system resonance, higher capacitor currents and possible capacitor burn-out.

Presently, tuned L-C shunt filters are most commonly used.

Some of the prior inventions as shown in U.S. Pat. No. 6,127,743 by Levin and U.S. Pat. No. 6,549,434 by Zhou teach the combinations of three elements, a series reactor, a shunt reactor in series with a capacitor. However, these prior inventions disclose filters having more than one windings with compensation winging as an integral part of the series reactor. Levin's invention also discloses a cross link circuit having a winding disposed on the same core as the line winding, which means that the shunt or the cross link reactor has flux linkages with other windings on the same core.

The present invention solves this problem by making the series reactor and the shunt reactor as an independent and isolated element with is winding wound on a separate core without flux linkage involved. The present invention is a mitigating harmonics which is purely dependant on the impedance ratio of the series reactor and the impendence of shunt or the cross link element as both the series and shunt reactance are made of constant inductance over broad spectrum of frequencies without flux linkage of any other winding involved.

The novel mitigating filter is simple in series and shunt reactor construction, simple in mitigating technique and very low in cost, as well as good mitigating harmonic performance.

### BRIEF SUMMARY OF THE INVENTION

The main objectives in developing a new filter is that one filter should be able to absorb all harmonics in high percentages. This has great significance in low initial cost for equipment and minimizing space required by the filtering equipment.

A further objective of new filter is that the filter should be very simple, reliable and maintenance free. Complex circuits such as the active filter should be avoided.

Yet another objective of the new filter is that the filter should be applicable regardless of the nature of the loads (including ASD, uninterruptible power supplies (UPS), arc furnaces, or D.C. transmission system), and regardless of the voltage levels, the of number of phases and the power frequencies.

Another objective of the new filter is that the filter should meet various critical performance criteria such as acceptable voltage regulation under power frequency operations from full load to half load, and good filtering efficiency resulting in acceptable total harmonic current distortion and total harmonic voltage distortion.

Another further objective of the new filter is that the filter parameters should be easily selected and designed to meet the requirements.

Three criteria are set for developing the invention.

First, a series reactor is needed to block the harmonics flowing from the load towards the source. This series reactor should be selected with power frequency voltage drop and harmonic voltage distortion considered.

Second, a shunt reactor in series with a capacitor is employed to absorb harmonics. Due to the fact that the 5th harmonic has the highest magnitude among harmonics in 3 phase systems, the relation between these two elements is set to achieve theoretically zero filter impedance at 5th harmonic, i.e. 5²× inductive reactance of shunt reactor=capacitive reactance of capacitor. Thus they become a theoretically zero impedance path for 5th harmonic in order to approach the theoretical limit of 100% filtering efficiency. This shunt impedance should become far smaller than the series impedance for all other high order harmonics. The capacitor would also serve for power factor correction and reduce the power frequency voltage drop during operations.

For single phase systems (including 3 phase 4 wire systems with single phase loads), the 3rd harmonic is of the highest magnitude among harmonics. The design concept is identical to that of 3 phase systems to achieve 100% filtering efficiency for 3rd harmonics.

Thus a basic single phase model of this invention is developed and consists of only three elements, i.e. a series reactor, X₁2, a shunt reactor X₂3 and a capacitor X_{C}4 as shown in FIG. 1 where the reactances represent the reactors and capacitor respectively.

The filtering efficiency of the filter can be controlled by proper design and selection of the components which in turn is based on a given system, equipment voltage tolerances and user's requirements such as filtering efficiency, required limits of power factor, voltage drop, harmonic distortion, etc. Further, the filter efficiency may be made adjustable by field adjustments of taps on the reactors.

With proper selection of the parameters of the filter, satisfactory performance results can be achieved, as shown in Table 1 and Table 2 in the detailed description of the invention.

For 3 phase applications, 3 filter units are needed while only one unit is required for single phase, two wire applications.

### BRIEF DESCRIPTION OF THE SEVERAL VIEWS OF THE DRAWINGS

FIG. 1 is a basic schematic view of a preferred embodiment of the invention. Both series reactor X₁2 and shunt rector X₂3 should be made of air (or non-magnetic) gapped core in order to obtain constant inductance over broad frequencies.

FIG. 2 is a three phase schematic view of a preferred embodiment with a three phase filter 111. Subscripts a, b, and c are utilized to identify elements and terminals in different phases. Because it is similar to FIG. 1, the single phase schematic view of a preferred embodiment except it is a three phase representation. Thus the detail of FIG. 2 will not be described again.

FIG. 3 is an other basic schematic view of a preferred embodiment of the invention. An additional shunt branch with a shunt reactor X₃21 in series with a capacitor X_{CC} is inserted in parallel with the shunt branch X₂3 in series with C₄.

In the figures, like elements are designated with similar reference numerals.

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

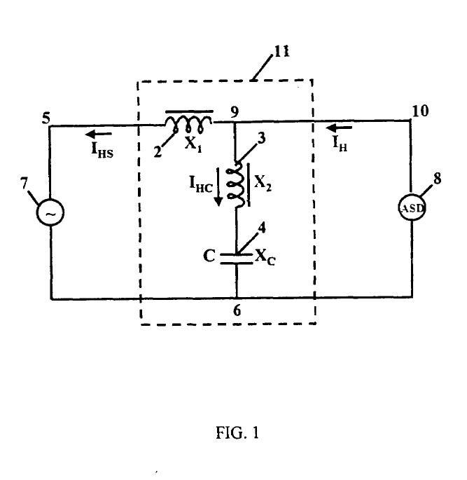

FIG. 1 shows a basic embodiment of the invented broad-spectrum harmonic filter consisting of 3 major elements: a series reactor X₁2, a shunt reactor X₂3 and a series capacitor C4 with shunt reactor X₂3 connected to terminal 9. The filter 11 is connected to a bus or a secondary side of an isolation transformer, not shown, at terminal 5. The supply side is represented as a source 7. The load side is shown as ASD 8, which in fact is an adjustable speed drive with its output connected to a 3-phase motor (not shown). The filter 11 is connected to the source at terminal 5 and to load at terminal 10. Point 6 is the neutral point of a three phase circuit and is a common connecting point for source, capacitor and load.

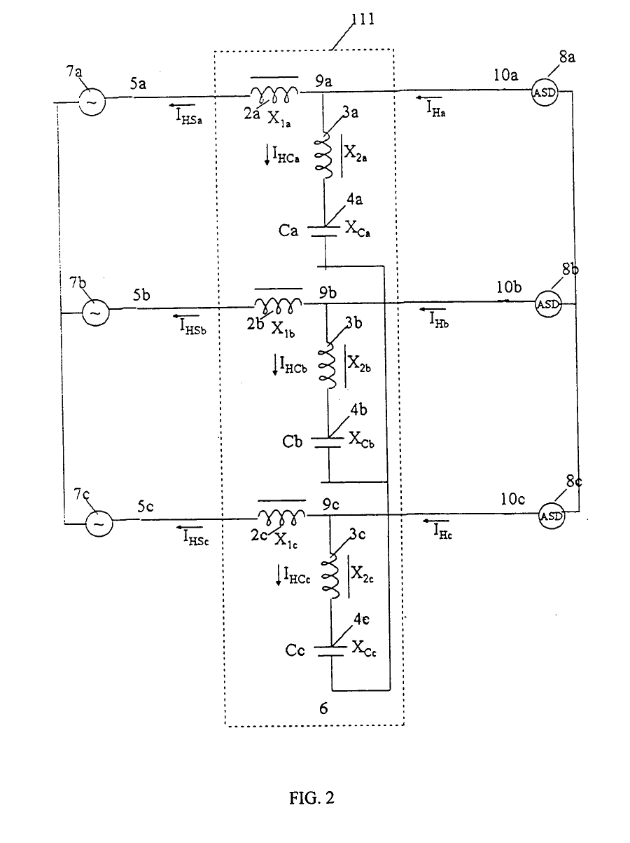

The magnitude of the impedance of the series reactor X₁2 is greater than that of X₂3 resulting in a low impedance path to capacitor C4 for all harmonics generated by load 8. In FIG. 1, terminal 9 and 10 are designated the same point for convenience of discussion. It is a common practice for a 0.03 pu (or higher) reactor to be installed ahead of an ASD in order to obtain reduced harmonics. FIG. 2 includes an additional series reactor X₃12. This series reactor X₃12 may represent the series reactor now commonly employed with ASD's.

The harmonic currents I_{H} flow toward series reactor X₁2 and shunt reactor X₂3 in series with capacitor C4. The portions of harmonic currents flowing between them can be determined by circuit theory as follows:

X₁I_{HS}=I_{HC}(X₂−X_{C}/h²)

where h is the harmonic order and I_{H}=I_{HS}+I_{HC}

X₁(I_{H}−I_{HC})=X₁I_{H}−X₁I_{HC}

∴I_{HC}=(X₁I_{H})/(X₁+X₂−X_{C}/h²) (1)

I_{HS}=(X₂−X_{C}/h²)I_{H}/(X₁+X₂−X_{C}/h²) (2)

Equation 1 shows that when h²X₂=X_{C}, I_{HC}=100% I_{H} that means for instance in 3 phase systems the 5th harmonic current flows completely toward the capacitor, with no portion flowing toward the source. The portion of higher order harmonics which flows toward the capacitor will decrease gradually toward a X₁/(X₁+X₂) limit.

Based on a typical harmonic spectrum and the selected parameters of the basic filter model, filtering efficiencies, reduction of total current distortion, the reduction of total harmonic voltage distortion and voltage regulation under power frequency operations were computed with satisfactory results. The harmonic currents fed back into the power system complies with IEEE Standard 519 limits. The individual harmonic current distortion is below 4% for those harmonics less than 11th order and total harmonic current distortion is below 5%. The selected parameters and performances are listed in Table 1.

In this calculation, per unit system was adopted: motor KVA=1.0 pu, system Voltage=1.0 pu.

The calculations are based on the typical harmonic spectrum as listed before. Achieved results will vary with power system, filter, and load parameters.

TABLE 1
X₁ = 0.15 pu X₂ = 0.08 pu X_{C} = 2 pu

| | | | | | | | | |
|---|---|---|---|---|---|---|---|---|
| Harmonic order (h) | 5 | 7 | 11 | 13 | 17 | 19 | 23 | 25 |
| Harmonic current (I_{H}) pu | 0.2 | 0.12 | .08 | .07 | .045 | .04 | .03 | .03 |
| Filtering Efficiency % | 100 | 79.3 | 70 | 68 | 67 | 67 | 66 | 66 |
| Harmonic current | 0 | .025 | .0238 | .0218 | .015 | .0133 | .01 | .01 |
| toward source (I_{SH}) pu | | | | | | | | |

Reduction of Total Harmonic Current Distortion = 100% − 18% = 72%
Reduction of Total Harmonic Voltage Distortion = 100% − 27.7% = 62.3%
Total Harmonic Current Distortion = .04763 pu

| | | | | |
|---|---|---|---|---|
| Voltage Regulation | Load Current Power Factor | 0.8 | 0.95 | 0.9 |
| Under power frequency | Full Load | 1.02 | 1.03 | 1.04 |
| operation, pu | | | | |

Notes:
1. Total Current Distortion = (Σ(I_{H})²)^{1/2}/I₁
Total Voltage Distortion = (Σ(I_{H} * h * x)²)^{1/2}/V₁
Where V₁ and 1 are the fundamental voltage and current.
I_{H} is the harmonic current, and h is the harmonic order.
And X is the reactance in which the harmonics flow through.
Reduction of Total Current Distortion = 100% − (current distortion with filter/current distortion without filter) × 100% = 100% − 0.04763/0.267 × 100% = 72%.
Reduction of Total Voltage Distortion = 100% − (voltage distortion with filter/voltage distortion without filter) × 100% = 100% − (0.651X/2.35X)100% = 62.3%.
2. Normally, the equipment input voltage range is 1.0 pu +/− 10%.

If existing system impedance at the point of connecting the filter and the load is considered, say 5% for conservatism, X₁ becomes (0.15 pu+0.05 pu)=0.2 pu. The filtering efficiency of the filter and the reduction of distortion are listed on Table 2. Obviously, Table 2 performance is better than that of Table 1 due to higher X₁ value.

TABLE 2
X₁ = 0.2 pu X₂ = 0.08 pu X_{C} = 2 pu

| | | | | | | | | |
|---|---|---|---|---|---|---|---|---|
| Harmonic | 5 | 7 | 11 | 13 | 17 | 19 | 23 | 25 |
| order (h) | | | | | | | | |
| Filtering | 100 | 83.6 | 76 | 75 | 73.2 | 72.9 | 72.4 | 72.3 |
| Efficiency | | | | | | | | |

Reduction of Total Current Distortion = 100% − .03834/0.267 ×100%
= (100 − 14.36) % = 86%
Reduction of Total Voltage Distortion = 100% − .529/2.35 ×100% = (100
− 22.5) % = 77.5%

In view of listed performance calculations in Table 1 and 2, a satisfactory result is demonstrated.

By proper selection of the 3 parameters, a desired filter and system performance can be achieved. Thus this simple basic model of filter is valid for applications.

However, due to the existence of X₁2, the total harmonic voltage distortion across X₁2 (or the filter) can be computed based on the given harmonic spectrum and filtering efficiency. The total harmonic voltage distortion of X₁2 due to flow of harmonics I_{HS} is VD_{X1}=0.651×0.15=0.0977 pu or 9.8% which is normally acceptable based on 10% limit shown in IEEE Standard 519.

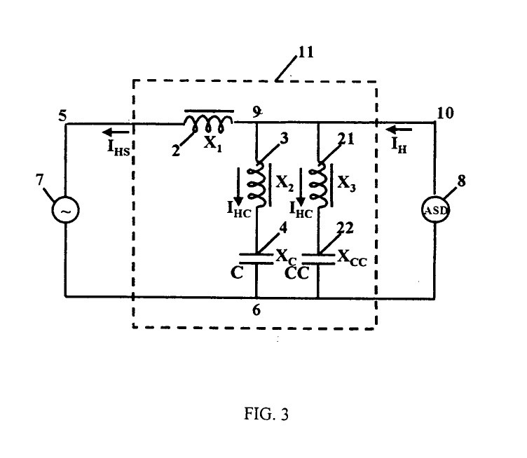

FIG. 3 shows another embodiment of the invented broad spectrum harmonic filter. As compared to FIG. 1, an additional shunt branch shunt branch with a shunt reactor X₃21 in series with a capacitor X_{CC} 22 is inserted in parallel with the shunt branch with X₂3 in series with C₄ as shown similarly in FIG. 1. X₃21 is also an individual component made of air (or non-magnetic) gapped core similar to X₁2 and X₂3 having the characteristics of constant inductance over broad frequencies. Due to the fact that they are made of individual cores, no flux linkages are involved.

Thus the harmonic current IH generated has three (3) paths to flow and can be expressed as:

I_{H}=I_{HS}+I_{HC}+I_{HCC} (3)

Similarly to the derivation of the equations (1) and (2), each portion of the harmonic flow can be determined as:

X₁I_{HS}=I_{HC}(X₂−X_{C}/h²)=I_{HCC}(X₃−X_{CC}/h²)

Thus

I_{HS}=(1/X₁)I_{H}/(1/X₁+1/(X₂−X_{C}/h²)+1/(X₃−X_{CC}/h²)) (4)

I_{HC}=(1/(X₂X_{C}/h²))I_{H}/(1/X₁+1/(X₂−X_{C}/h²)+1/(X₃−X_{CC}/h²)) (5)

I_{HCC}=(1/(X₃−X_{CC}/h²))I_{H}/(1/X₁+1/(X₂−X_{C}/h²)+1/(X₃−X_{CC}/h²)) (6)

When selecting h²X₂=X_{C}, I_{HC}=100% I_{H} as described before, similarly h²X₃=X_{CC}, I_{HCC}=100% I_{H}.

If h=5 for X₂3 shunt branch and h=7 for X₃21 are selected in 3 phase systems, both 5th and 7th harmonic currents will flow toward shunt branches nearly completely without 5th and 7th harmonic currents will flow toward the source.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A controllable broad-spectrum harmonic filter of single phase type for electrical power systems comprising:
a) a series reactor of high magnitude without compensation winding,
b) a shunt reactor of low magnitude, and
c) a capacitor in series with the shunt reactor,
wherein a load is connected to the shunt reactor and the capacitor in series, and the performance of this filter is determined by the selection of values of the series reactor, the shunt reactor, and the capacitor.

2. A controllable broad-spectrum harmonic filter of single phase type for electrical power systems as in claim 1, wherein windings of the series reactor and the shunt reactor are disposed on separate air gapped cores without flux linkage involved between the series reactor and the shunt reactor.

3. A controllable broad-spectrum harmonic filter of single phase type for electrical power systems as in claim 1, wherein a shunt reactor replaces a L-C type shunt filter to function as a low impedance path for harmonics wherein said shunt reactor functions as a high inductance reactance under such power frequency and become a low inductive reactance over broad harmonic frequencies.

4. A controllable broad-spectrum harmonic filter of single phase type for electrical power systems as in claim 1, wherein an additional shunt reactor may be utilized in parallel with shunt reactor in series with a capacitor to draw power frequency reactive current to compensate the capacitive current and to reduce voltage rise across the series reactor to a desired value.

5. A controllable broad-spectrum harmonic filter of single phase type for electrical power systems as in claim 1, wherein an additional set of a shunt reactor of low magnitude in series with a capacitor is connected in parallel with the original set of a shunt reactor in series with a capacitor to achieve better filtering performance of the unit.

6. A controllable broad-spectrum harmonic filter of a 3-phase unit for electrical power systems comprising:
a) three sets of a series reactor of high magnitude without compensation winding,
b) three sets of a shunt reactor of low magnitude, and
c) three sets of a capacitor in series with the shunt reactor.
wherein the performance of this filter is determined by the selection of values of the series reactor, the shunt reactor, and the capacitor and wherein a 3-phase unit consisting of three single phase units may be constructed for 3-phase applications.

7. A controllable broad-spectrum harmonic filter of 3-phase type for electrical power systems as in claim 6, wherein three additional sets of a shunt reactor of low magnitude in series with a capacitor is connected in parallel with the original three sets of a shunt reactor in series with a capacitor respectively and wherein a 3-phase unit consist of three single phase units may be constructed for 3-phase applications to achieve better filtering performance of the unit.
